(19) United States
(12) Patent Application Publication
(10) Pub. No.: US 2012/0050504 A1
(43) Pub. Date: Mar. 1, 2012

(54) DIGITAL TELEVISION RECEIVING APPARATUS AND ON-VEHICLE APPARATUS PROVIDED WITH THE SAME

(76) Inventor: Michinao Asano, Iwaki (JP)

(21) Appl. No.: 13/177,288

(22) Filed: Jul. 6, 2011

(30) Foreign Application Priority Data
Aug. 27, 2010 (JP) JP 2010-190511

(51) Int. Cl. H04N 13/04

(52) U.S. Cl. 348/54; 348/E13.026

(57) ABSTRACT

A digital television receiving apparatus eliminates user discomfort when a 3D vision program is displayed on a display that does not support a 3D vision program. The receiving apparatus includes a 3D vision program determination unit which determines if the broadcast program is displayable as a 3D image using a left view image and a right view image. A display control unit is configured to cause the left view image or the right view image of the broadcast program to be undisplayable when it is determined that the broadcast program is a 3D vision program.

### PRIORITY CLAIM

This application claims the benefit of Japanese Patent Application No. 2010-190511, filed on Aug. 27, 2010, and which is incorporated by reference herein in its entirety.

### BACKGROUND

1. Field of the Invention

The present invention relates to a digital television receiving apparatus which displays, on a display, an image of a broadcast program on a channel selected at a receiver that receives digital television broadcasting, and an on-vehicle apparatus provided with the digital television receiving apparatus.

2. Description of the Related Art

In recent years, a digital television apparatus provided with a display device capable of displaying a 3D image is more and more commonly used along with the spread of digital television broadcast. A special instrument or device, such as “a pair of glasses”, is needed to watch the 3D image. For this reason, it is difficult to casually watch 3D images at any time. Further, under the current circumstances, not all of the broadcast programs on a channel which can be watched by receiving digital television broadcasting are 3D vision programs displayable in the 3D images, and conventionally-broadcasted 2D vision programs displayable in 2D images are also broadcasted at the same time. In other words, both 3D vision programs and 2D vision programs are broadcasted in a coexistent manner.

In light of such current circumstances where the 2D vision programs and the 3D vision programs are broadcasted in a coexistent manner, an image display apparatus has been suggested (in JP2006-121553 A) in which dimension converting operation can be controlled in a display apparatus capable of displaying both 2D images and 3D images. For causing the image display apparatus to display a 2D image, the 2D image is displayed based on a 2D image signal or displayed, after converting a 3D image signal into a 2D image signal, based on the converted 2D image signal. On the other hand, for causing the image display apparatus to display a 3D image, the 3D image is displayed based on the 3D image signal or displayed, after converting a 2D image signal into a 3D image signal, based on the converted 3D image signal.

However, in the image display apparatus described in JP2006-121553 A, although it is possible to convert the 3D image signal (3D vision program) into the 2D image signal (2D vision program) upon receipt of the 3D image signal, various circuits are needed to convert a dimension of a image signal, resulting in an increased unit cost of upsizing and manufacturing the image display apparatus. Moreover, in the case of an image display apparatus which is not adapted to display an image of a 3D vision program, when the 3D vision program is selected, substantially identical images are separately displayed into a left view image and a right view image, causing a user cannot easily fix his or her vision on the image and rather have difficulty in viewing a display screen. Thus, the user may sometimes feel this uncomfortable.

### SUMMARY

The present invention, which was conceived in view of the aforesaid current circumstances, provides a digital television receiving apparatus capable of eliminating occurrence of a discomfort feeling caused by a 3D vision program displayed on a display which is not adapted to display any 3D vision program.

A digital television receiving apparatus according to the present invention, in which an image of a broadcast program on a channel selected at a receiver that receives digital television broadcasting is displayed on a display, comprises a 3D vision program determination means which determines whether or not the broadcast program on the selected channel is a 3D vision program displayable in a 3D image using a left view image and a right view image, and a display control means which makes at least any one of the left view image and the right view image of the broadcast program undisplayed on the display on the selected channel when it is determined that the broadcast program on the selected channel is the 3D vision program.

According to the above-described configuration, when the 3D vision program determination means, which determines whether or not the broadcast program on the selected channel is a 3D vision program displayable as a 3D image using a left view image and a right view image, determines that the broadcast program on the selected channel is the 3D vision program, the display control means makes at least any one of the left view image and the right view image of the broadcast program on the selected channel undisplayed on the display. Thus, a situation where substantially identical images are displayed on the display is prevented, and a discomfort feeling that a user experiences because of such a display can be eliminated.

In the digital television receiving apparatus according to the present invention, the display control means may be configured to make any one of the left view image and the right view image displayed on the display when it is determined that the broadcast program on the selected channel is the 3D vision program.

According to the above-described configuration, when the 3D vision program determination means determines that the broadcast program on the selected channel is a 3D vision program, any one of the left view image and the right view image may be displayed on the display by the display controlling unit. Thus, a user can watch the image displayed on the display without a discomfort feeling.

In the digital television receiving apparatus according to the present invention, the display control means may be configured to make any one of the left view image and the right view image and another image displayed respectively on different regions of the display, when it is determined that the broadcast program on the selected channel is the 3D vision program.

According to the above-described configuration, when the 3D vision program determination means determines that the broadcast program on the selected channel is a 3D program, any one of the left view image and the right view image and another image are displayed on different regions of the display respectively by the display control means. Thus, a situation where substantially identical images are displayed on the display in a mixed manner is prevented. Thus, a user can easily select an image to fix his or her vision.

The digital television receiving apparatus according to the present invention may comprise a program searching means which searches for at least another broadcast program that is broadcasted in a same time frame as a broadcast hour of the 3D vision program when it is determined that the broadcast program on the selected channel is the 3D vision program. Further, the display control means may be configured to make a search result found by the program searching means displayed on the display as another image along with the any one of the left view image and the right view image.

According to the above-described configuration, the display control means causes the program searching means to search for at least another broadcast program that is broadcasted in a same time frame as a broadcast hour of the 3D vision program. Thus, a user can watch the search result found by the program searching means and any one of the left view image and the right view image displayed on the display, and can easily recognize the broadcast program on another channel. Further, when the searched broadcast program on another channel is selected, an image of the selected broadcast program (a 2D vision program) can be displayed on the display.

In the digital television receiving apparatus according to the present invention, the display control means may be configured to make both the left view image and the right view image undisplayed on the display when it is determined that the broadcast program on the selected channel is the 3D vision program.

According to the above-described configuration, when the 3D vision program determination means determines that the broadcast program on the selected channel is the 3D vision program, the display control means makes both the left view image and the right view image undisplayed on the display. Thus, the user can easily recognize that the broadcast program on the selected channel is not available.

The digital television receiving apparatus according to the present invention may comprise a search means which searches for a 2D vision program providing an image which has a same content as the 3D vision program and does not have a separation between the left view image and the right view image, when the 3D vision program determination means determines that the broadcast program on the selected channel is the 3D vision program. The display control means may be configured to make a 2D image of the 2D vision program found by the search means displayed on the display.

According to the above-described configuration, when the 3D vision program determination means determines that the broadcast program on the selected channel is a 3D vision program, because the search means searches for a 2D vision program which has a same content as the 3D vision program, and the display control means makes a 2D image (in which there is no separation between the left view image and the right view image) of the 2D vision program found by the search means displayed on the display, the user can watch a 2D image having an identical content with the broadcast program (the 3D vision program) on the selected channel.

The digital television receiving apparatus according to the present invention may comprise a reporting means which provides predetermined report information when the 3D vision program determination means determines that the broadcast program on the selected channel is a 3D vision program.

According to the above-described configuration, when the 3D vision program determination means determines that the broadcast program on the selected channel a 3D vision program, because the reporting means provides the predetermined report information, a user can readily recognize that the broadcast program on the selected channel is not available when the broadcast program on the selected channel is a 3D vision program.

In the digital television receiving apparatus according to the present invention, the reporting means may be configured to display a predetermined message on the display where neither the left view image nor the right view image is displayed.

According to the above-described configuration, when the 3D vision program determination means determines that the broadcast program on the selected channel is a 3D vision program, because the reporting means displays the message on the display where neither the left view image nor the right view image is displayed, a user can, upon visual perception of the message, readily recognize that the broadcast program on the selected channel is not available.

The digital television receiving apparatus according to the present invention may comprise a 2D vision program priority setting means which enables a setting to make any image of the 3D vision program undisplayed on the display. When the 3D vision program determination means determines that the broadcast program on the selected channel is the 3D vision program in a state where the setting to make the 3D image of the 3D vision program undisplayed on the display is enabled by the 2D vision program priority setting means, the display control means may provide a predetermined message without displaying any of the left view image and the right view image.

According to the above-described configuration, when the 3D vision program determination means determines that the broadcast program on the selected channel is the 3D vision program in a state where the setting to make a 3D image of the 3D vision program undisplayed on the display is enabled by the 2D vision program priority setting means, because the display controlling means provides a predetermined message without displaying any of the left view image and the right view image on the display, a user can readily recognize that the broadcast program on the selected channel is not viewable.

In the digital television receiving apparatus according to the present invention, when the 3D vision program determination means determines that the broadcast program on the selected channel is the 3D vision program in a state where the setting to make any image of the 3D vision program undisplayed on the display is disabled by the 2D vision program priority setting means, the display control means may be configured to make at least any one of the left view image and the right view image of the broadcast program on the selected channel undisplayed on the display.

According to the above-described configuration, when the 3D vision program determination means determines that the broadcast program on the selected channel is the 3D vision program in a state where the setting to make any image of the 3D vision program undisplayed on the display is disabled by the 2D vision program priority setting means, because the display control means makes at least any one of the left view image and the right view image of the broadcast program undisplayed on the display on the selected channel, a user can watch an image of the broadcast program on the selected channel regardless of whether the image of the broadcast program on the selected channel is of the 2D vision program or of the 3D vision program.

An on-vehicle apparatus according to the present invention comprises the digital television receiving apparatus recited in any one of claims 1 to 10 and a navigation apparatus which causes the display to display navigation information for assisting drive operation of a driver.

According to the above-described configuration, because there is no possibility that substantially identical images are displayed on the display in the digital television receiving apparatus, a discomfort feeling that a user experiences when watching such an display can be eliminated. In addition, the navigation information by the navigation apparatus which is also installed in the on-vehicle apparatus can be recognized on the display of the digital television receiving apparatus.

In the on-vehicle apparatus according to the present invention, when the 3D vision program determination means determines that the broadcast program on the selected channel is the 3D vision program, the display control means may be configured to cause the display to display any one of the left view image and the right view image of the broadcast program on the selected channel and the navigation information respectively on different regions of the display.

According to the above-described configuration, when the 3D vision program determination means determines that the broadcast program on the selected channel is a 3D vision program, because any one of the left view image and the right view image of the broadcast program on the selected channel and the navigation information are displayed on different regions of the display respectively by the display control means, a user can watch both any one of the left view image and the right view image and the navigation information at the same time.

The digital television receiving apparatus according to the present invention comprises the display control means which makes, when the 3D vision program determination means that determines whether or not a broadcast program on a selected channel is a 3D vision program displayable in a 3D image using a left view image and a right view image determines that the broadcast program on the selected channel is the 3D vision program, at least any one of the left view image and the right view image of the broadcast program on the selected channel undisplayed on the display. Therefore, there is no possibility that substantially identical images are displayed on the display, and a discomfort feeling that occurs when a user watches such a display can be eliminated.

### BRIEF DESCRIPTION OF THE DRAWINGS

FIG. 1 is a block diagram showing an on-vehicle apparatus with a digital television receiving apparatus and a navigation apparatus, according to an embodiment of the present invention;

FIG. 2 is a flowchart showing process steps in a control unit;

FIG. 3 shows a (first exemplary) screen displayed on the display by the control unit;

FIG. 4 shows a (second exemplary) screen displayed on the display by the control unit;

FIG. 5 shows a (third exemplary) screen displayed on the display by the control unit;

FIG. 6 shows a (fourth exemplary) screen displayed on the display by the control unit;

FIG. 7 shows a (fifth exemplary) screen displayed on the display by the control unit, and

FIG. 8 shows a (sixth exemplary) screen displayed on the display by the control unit.

### DETAILED DESCRIPTION OF PREFERRED EMBODIMENT

Hereinafter, an embodiment of the present invention will be described with reference to the drawings.

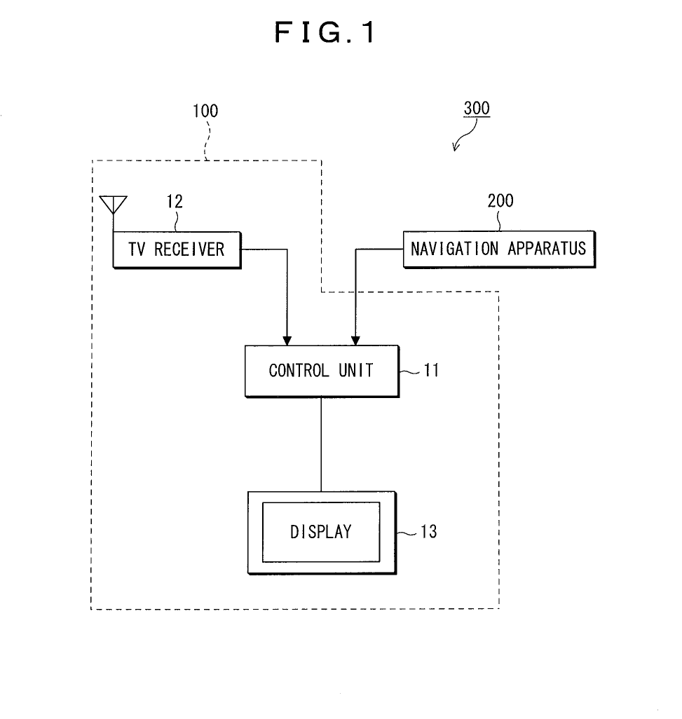

An on-vehicle apparatus to which a digital television receiving apparatus according to an embodiment of this invention and a navigation apparatus are applied is configured as shown in FIG. 1. In FIG. 1, an on-vehicle apparatus 300 includes a digital television receiving apparatus 100 and a navigation apparatus 200. The digital television receiving apparatus 100 has a control unit 11 composed of a computer unit (including a CPU). The control unit 11 is connected to a TV receiver 12 which receives a broadcast program broadcasted on each television station (each channel), and a display 13 on which an image of the broadcast program received by the TV receiver 12 is displayed. In this configuration, the control unit 11 can cause the display 13 to display the broadcast program on each channel received by the TV receiver 12. By means of the thus-configured television receiving apparatus 100, a user can freely watch (view) a broadcast program on a channel selected by the user. It should be noted that the display 13 is a display designed specifically for 2D images that is capable of displaying 2D images but incapable of displaying 3D images.

On the other hand, the navigation apparatus 200 has a processing unit composed of a not-illustrated computer unit (including a CPU). The processing unit is connected to, for example, a GPS unit, sensors and the like that provides location information needed to navigate a vehicle, and also connected to a storage unit that stores map information and a variety of information. Further, in the processing unit, an operating unit such as an operation button is provided together with an output circuit that outputs an audio signal to a speaker which is mounted on a vehicle interior. Using these components, the processing unit performs processing associated with the vehicle navigation based on both the location information from the GPS unit, sensors and the like and the map information retrieved from the storage unit. In the processing associated with the vehicle navigation, a route from a vehicle location to a destination is found and established based on the vehicle location obtained from the GPS unit, sensors and the like and a location of the destination, and then a map related to the navigation, a mark indicating the vehicle location, and the established route are displayed through the control unit 11 on the display 13, for outputting (displaying or vocally-outputting) guidance and the like related to vehicle routing assistance.

As such, the display 13 in the digital television receiving apparatus 100 also functions as a display for the navigation apparatus 200. The not-illustrated speaker which is also installed in the navigation apparatus 200 can perform, via the control unit 11, audio-output of a broadcast program on the selected channel received by the TV receiver 12 of the television receiving apparatus 100. In this way, the digital television receiving apparatus 100 and the navigation apparatus 200 are adapted to function as the on-vehicle apparatus 300 in a reciprocally associated manner.

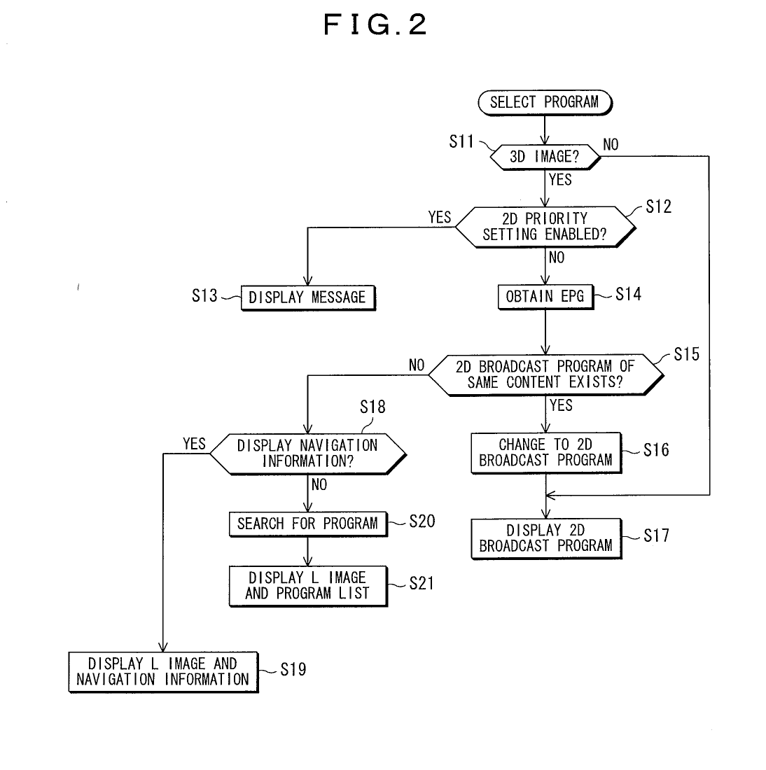

Process steps for displaying, on the display 13, the broadcast program on a channel selected by the user and received by the TV receiver 12 of the control unit 11 in the above-described on-vehicle apparatus 300 are performed as shown in FIG. 2.

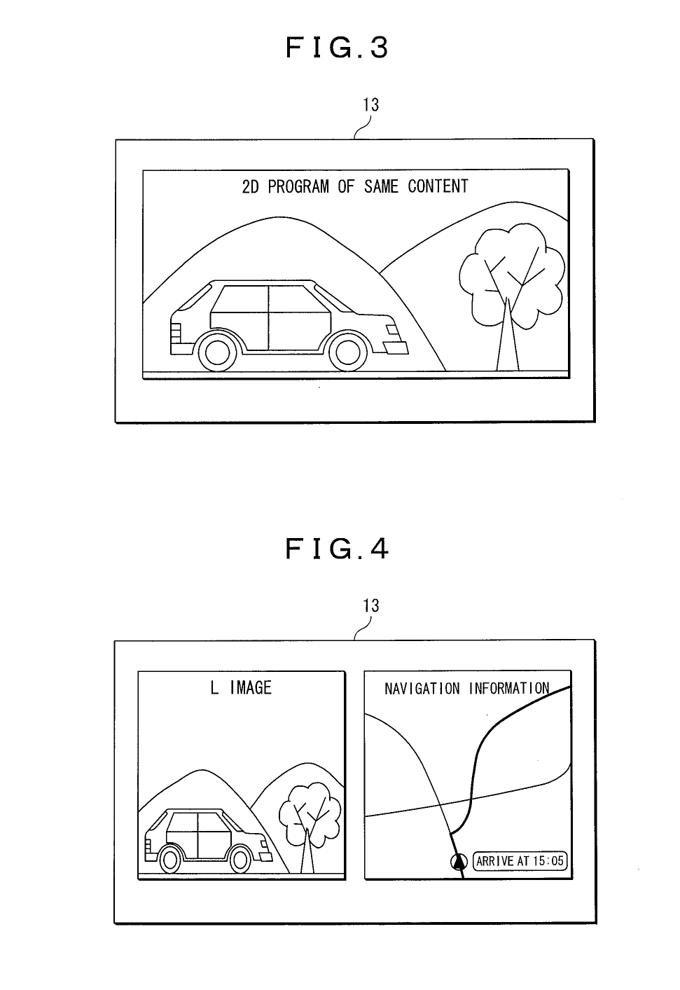

In FIG. 2, the user firstly selects a channel in which a broadcast program that the user wants to watch is on-air. Then, the control unit 11 determines whether or not the broadcast program on the channel selected by the user is a 3D vision program (S11). In general, when a certain 3D vision program is received via the TV receiver 12 on the display 13 designed specifically for 2D images, the 3D vision program cannot be displayed in a stereoscopic image on the display 13 and displayed separately into a left view image and a right view image on designated regions of the display 13, for example, as shown in FIG. 8. However, in the digital television receiving apparatus 100 according to the present invention, whether or not the broadcast program is the 3D vision program which can be displayed as a 3D image using the left view image and the right view image is determined (3D vision program determination means). The control unit 11 makes the determination, for example, based on a type of an image signal of the broadcast program on the channel received by the TV receiver 12. When it is not determined that the broadcast program on the channel selected by the user is the 3D image (NO in S11), the control unit 11 causes the display 13 to display, as shown in FIG. 3, the selected program which is not in the 3D image (2D image), for example (S17).

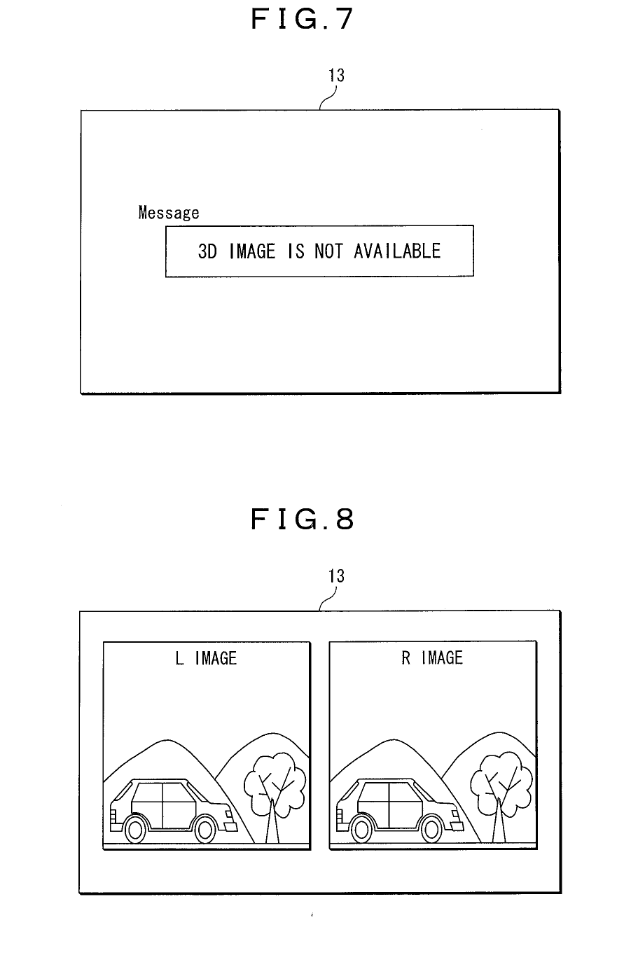

On the other hand, when it is determined that the broadcast program on the channel selected by the user is the 3D vision program (YES in S11), the control unit 11 determines whether or not a setting to make any image of the 3D vision program undisplayed on the display 13 is enabled (S12). Specifically, whether or not the setting to make any image of the 3D vision program undisplayed on the display 13 (2D vision program priority setting means) is enabled by the user is determined. In this way, when it is determined that the setting to make any image of the 3D vision program undisplayed on the display 13 is enabled (YES in S12), the control unit 11 causes, without allowing the display 13 to display any of the left view image and the right view image, the display 13 to display a predetermined message (such as a message denoting that any 3D image is not available) as shown in FIG. 7 (reporting means), for example (S13). This allows the user to readily recognize that the broadcast program on the channel selected by the user himself or herself is not available. It should be noted that, although in this case, the predetermined message denoting that any 3D image is not available is displayed on the display 13 by the control unit 11, an alarm may be sounded from the not-illustrated speaker, of course.

On the other hand, when it is determined that the setting to make any image of the 3D vision program undisplayed on the display 13 is disabled (NO in S12), the control unit 11 obtains, via the TV receiver 12, an electronic program guide (EPG) in which broadcast programs on other channels are listed (S14). Then, the control unit 11 performs search on the EPG (Electronic Program Guide) to find a 2D vision program which has a same content as the 3D vision program, and determines whether or not such a 2D vision program is present (S15). In this process, when it is determined that the 2D vision program which has a same content as the broadcast program on the channel selected by the user is present (YES in S15), the control unit 11 changes the channel selected by the user to a channel on which the 2D vision program found by the search is broadcasted (S16). Then, the control unit 11 causes the display 13 to display the 2D vision program, which is obtained through the above-described process S15, broadcasted on the channel changed as described above (S17), as shown in FIG. 3.

On the other hand, when it is determined that the 2D vision program which has a same content as the broadcast program on the channel selected by the user is absent (NO in S15), the control unit 11 determines whether or not to display the navigation information on the display 13 (S18). In this process, when it is determined that the navigation information is displayed on the display 13 (YES in S18), the control unit 11 displays the left view image (L image) and the navigation information respectively on different regions of the display 13 as shown in FIG. 4, for example. This allows the user to recognize, on watching the display 13, both the left view image (L image) and the navigation information at the same time.

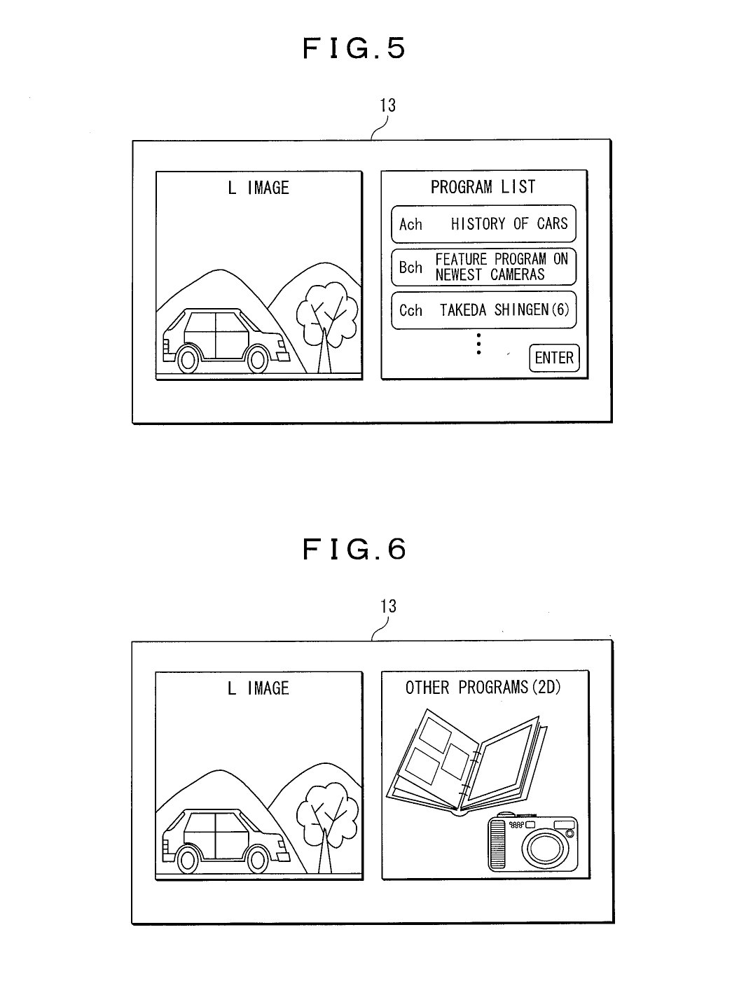

In addition, in the above process step S18, when it is determined that the navigation information is not displayed on the display 13 (NO in S18), the control unit 11 conducts, based on the above-described electronic program guide (EPG), a search for another broadcast program which is broadcasted in a same time frame as a broadcast hour of the broadcast program (the 3D vision program) on the channel selected by the user (a program searching means) (S20). Then, the control unit 11 causes the display 13 to display a program list found as a search result in the above-described process S20 along with the left view image (L image) as shown in FIG. 5, for example (S21). When the user selects a broadcast program on another channel from thus-displayed program list, the control unit 11 may display an image (2D image) of the newly selected broadcast program on the entire display 13 without displaying the left view image (L image). Alternatively, both the image of the broadcast program on the another channel and any one of the left view image (L image) and the right view image (R image) of the 3D vision program may be displayed on the display 13 as shown in FIG. 6, for example.

It should be noted that, although the left view image of the 3D vision program is displayed on the display 13 in the above-described process S19 and S21, the right view image (R image) may be displayed, of course. Further, when it is determined that the broadcast program on the selected another channel is the 3D vision program, the display 13 may be caused to display neither the left view image nor the right view image.

As described above, in the digital television receiving apparatus according to the present invention, when the 3D vision program determination means that determines whether or not a broadcast program on a selected channel is a 3D vision program displayable in a 3D image using a left view image and a right view image determines that the broadcast program on the selected channel is the 3D vision program, the display control means makes at least any one of the left view image and the right view image of the broadcast program on the selected channel undisplayed on the display. Thus, there is no possibility that substantially identical images are displayed on the display. Therefore, the present invention has an effect of eliminating a discomfort feeling that a user experiences when watching such an display, and the present invention can usefully be embodied as a digital television receiving apparatus which displays an image of the broadcast program on the channel selected at a receiver that receives digital television broadcasting, and as an on-vehicle apparatus provided with the digital television receiving apparatus.

Although preferred embodiments have been described in detail, the present invention is not limited to these specific embodiments of the present invention. Rather, various modifications and changes can be made without departing from the scope of the present invention as described in the accompanying claims. Accordingly, all such modifications are intended to be included within the scope of this invention as defined in the following claims.

What is claimed is:

1. A digital television receiving apparatus having a receiver that receives a digital broadcast program on a selected channel, and having a display that displays an image of the digital broadcast program, the receiving apparatus comprising:
a 3D vision program determination unit which determines if the broadcast program is displayable as a 3D image using a left view image and a right view image; and
a display control unit configured to cause the left view image or the right view image of the broadcast program to be undisplayable on the display when it is determined that the broadcast program is a 3D vision program.

2. The digital television receiving apparatus according to claim 1, wherein:
the display control unit causes the left view image or the right view image to be displayed on the display when it is determined that the broadcast program is a 3D vision program.

3. The digital television receiving apparatus according to claim 2, wherein the display control unit causes the display to display the left view image or the right view image and another image, respectively on different regions of the display when it is determined that the broadcast program is a 3D vision program.

4. The digital television receiving apparatus according to claim 3, further comprising:
a program search unit configured to search for at least another broadcast program which is broadcast in a same time frame as the 3D vision program, when it is determined that the broadcast program is a 3D vision program; and
wherein the display control unit causes a search result by the program search unit to be displayed on the display as the another image along with the left view image or the right view image.

5. The digital television receiving apparatus according to claim 1,
wherein the display control unit causes the left view image and the right view image to be undisplayable when it is determined that the broadcast program is a 3D vision program.

6. The digital television receiving apparatus according to claim 5, further comprising:
a search unit configured to search for a 2D vision program that provides a 2D image having the same content as the 3D vision program and does not have a separation between the left view image and the right view image, when it is determined that the broadcast program is a 3D vision program; and wherein
the display control unit causes the display to display the 2D image of the 2D vision program found by the search unit.

7. The digital television receiving apparatus according to claim 5, further comprising a reporting unit configured to output predetermined report information when the 3D vision program determination unit has determined that the broadcast program is a 3D vision program.

8. The digital television receiving apparatus according to claim 7, wherein the reporting unit causes the display to display a predetermined message when the left view image and the right view image are undisplayable.

9. The digital television receiving apparatus according to claim 1, further comprising:
a 2D vision program priority setting unit configured to disable displaying of a 3D vision program; wherein
the display control unit outputs a predetermined message to the display and prevents displaying of the left view image and the right view image, when the 3D vision program determination unit determines that the broadcast program is a 3D vision program and the 2D vision program priority setting disables the displaying of a 3D vision program.

10. The digital television receiving apparatus according to claim 1, wherein the display control unit prevents displaying of the left view image or the right view image of the broadcast program when the 3D vision program determination unit determines that the broadcast program is a 3D vision program and when the 2D vision program priority setting unit has disabled displaying of a 3D vision program.

11. An on-vehicle apparatus comprising:
the digital television receiving apparatus according to claim 1, and
a navigation apparatus configured to cause displaying of navigation information.

12. The on-vehicle apparatus according to claim 11, wherein the display control unit causes the display to display, on different regions of the display, both the navigation information, and the left view image or the right view image of the broadcast program respectively, when the 3D vision program determination unit determines that the broadcast program is a 3D vision program.

13. A digital television receiving method for displaying, on a display, an image of a broadcast program on a channel selected on a receiver that receives digital television broadcasting, the method comprising:
determining, in a 3D vision program determination step, if the broadcast program is a 3D vision program that can be displayed as a 3D image using a left view image and a right view image, and
preventing at least one of the left view image and the right view image of the broadcast program from being displayed on the display when it is determined that the broadcast program is a 3D vision program.

14. The digital television receiving method according to claim 13, wherein the 3D vision program determination step includes causing the display to display the left view image or the right view image when it is determined that the broadcast program is a 3D vision program.

15. The digital television receiving method according to claim 14, wherein the display controlling step includes causing the display to display the left view image or the right view image, and another image, on different regions of the display respectively, when it is determined that the broadcast program is a 3D vision program.

16. The digital television receiving method according to claim 15, further comprising:
searching for at least another broadcast program that is broadcast in a same time frame as the 3D vision program when it is determined that the broadcast program is a 3D vision program and;
displaying a search result as the another image along with the left view image or the right view image.

17. The digital television receiving method according to claim 13, wherein the display controlling step includes preventing the left view image and the right view image from being displayed when it is determined that the broadcast program is a the 3D vision program.

18. The digital television receiving method according to claim 17, further comprising:
conducting a search for a 2D vision program providing a 2D image which has a same content as that of the 3D vision program and does not have a separation between the left view image and the right view image, when it is determined that the broadcast program is a 3D vision program; and
displaying the 2D image of the 2D vision program found in the 2D vision search.

19. The digital television receiving method according to claim 17, further comprising:
outputting predetermined report information when it is determined that the broadcast program is a 3D vision program.

20. The digital television receiving method according to claim 19, wherein outputting the predetermined report information includes displaying a predetermined message and preventing displaying of the left view image and the right view image.
